(19) United States
(12) Patent Application Publication
(10) Pub. No.: US 2026/0360098 A1
(43) Pub. Date: Nov. 12, 2026

(54) Triangulation Based Point Cloud Filtering

(71) Applicant: Microvision, Inc., Redmond, WA (US)

(72) Inventor: Justin Odle, Redmond, WA (US)

(73) Assignee: Microvision, Inc., Redmond, WA (US)

(21) Appl. No.: 19/200,485

(22) Filed: May 6, 2025

(51) Int. Cl. G06T 19/20; G01S 17/89; G06V 10/762

(52) U.S. Cl. CPC G06T 19/20; G01S 17/89; G06V 10/762; G06T 2219/2021

(57) ABSTRACT

Aspects of the subject disclosure may include, for example, a light detection and ranging system that filters noisy point cloud data by triangulating data points, removing edges based on properties, detecting clusters, and discarding irrelevant clusters. The final clusters represent real objects, improving accuracy for applications like autonomous vehicles and mapping. The system may dynamically adjust field of view, resolution, and laser power based on cluster properties. Other embodiments are disclosed.

### FIELD OF THE DISCLOSURE

The subject disclosure relates to light detection and ranging (LIDAR) systems that scan laser light pulses in a field of view.

### BACKGROUND

Systems that detect and measure distances to objects are widely used for various applications, including autonomous vehicles, robotics, and environmental mapping. These systems rely on scanning light pulses across a field of view to detect and measure distances to objects. The performance of these systems, measured by metrics such as accuracy, precision and efficiency, depend significantly on the quality of the point cloud data that is collected by these systems.

### BRIEF DESCRIPTION OF THE DRAWINGS

Reference will now be made to the accompanying drawings, which are not necessarily drawn to scale, and wherein:

FIG. 1 shows a LIDAR system with scanning mirror assemblies in accordance with various aspects described herein;

FIG. 2 shows an automotive application of a LIDAR system with scanning mirror assemblies in accordance with various aspects described herein;

FIG. 3 shows a block diagram of a control logic in accordance with various aspects described herein;

FIG. 4 shows a scanning mirror assembly in accordance with various aspects described herein;

FIG. 5 shows a scanning mirror assembly without a mirror in accordance with various aspects described herein;

FIG. 6 shows a block diagram of transmit drive circuitry, scanning mirrors, and a laser module in accordance with various aspects described herein;

FIG. 7 shows triangulation of a set of data points in a point cloud in accordance with various aspects described herein;

FIG. 8 shows a cluster of data points and removed edges in accordance with various aspects described herein;

FIG. 9 shows removed clusters and a final set of clusters in accordance with various aspects described herein;

FIG. 10 shows a side view of a transmit module in accordance with various aspects described herein;

FIG. 11 shows a top view of a transmit module in accordance with various aspects described herein;

FIG. 12 shows a side view of a receive module in accordance with various aspects described herein;

FIG. 13 shows a top view of a receive module in accordance with various aspects described herein;

FIG. 14 shows a perspective view of an integrated photonics module in accordance with various aspects described herein;

FIG. 15 shows a cross sectional top view of the integrated photonics module of FIG. 14; and

FIGS. 16 and 17 depict illustrative embodiments of methods in accordance with various aspects described herein.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. Like numerals in the drawings refer to the same or similar functionality throughout the several views.

One or more aspects of the subject disclosure include a light detection and ranging (LIDAR) system comprising a laser light source, at least one light-sensitive device, at least one time-of-flight measurement circuit responsive to the at least one light-sensitive device, a point cloud storage device to store a set of data points as measured by the at least one time-of-flight measurement circuit, and a processing system including a processor. The processing system is coupled to the point cloud storage device and includes a memory that stores executable instructions that, when executed by the processing system, facilitate performance of operations. The operations may include triangulating the set of data points in the point cloud storage device to form a set of triangles, wherein each triangle in the set of triangles includes edges and vertices; removing edges from the set of triangles based on one or more properties of each triangle in the set of triangles to produce a filtered set of triangles; detecting clusters of data points to produce detected clusters, wherein each cluster of the detected clusters comprises data points connected by edges of the filtered set of triangles; and removing at least one of the detected clusters based on a property of the detected clusters, resulting in a final set of clusters. Not all embodiments include removing at least one of the detected clusters. For example, in a point cloud that is already of sufficient quality, a sufficient number of points may be eliminated simply by removing triangle edges and all of the resulting clusters may be retained. In these embodiments, the points would have been filtered but no clusters would have been removed.

One or more aspects of the subject disclosure include a system comprising a light detection and ranging (LIDAR) sensor configured to generate a point cloud that includes a set of data points, a processing system including a processor, the processing system being coupled to the LIDAR sensor, and a memory that stores executable instructions that, when executed by the processing system, facilitate performance of operations. The operations may include triangulating the set of data points in the point cloud to form a set of triangles, wherein each triangle in the set of triangles includes edges and vertices; removing edges from the set of triangles based on one or more properties of each triangle in the set of triangles to produce a filtered set of triangles; detecting clusters of data points, wherein each cluster of the clusters comprises data points connected by edges of the filtered set of triangles; and removing at least one of the clusters based on a property of the clusters, resulting in a final set of clusters representing likely real objects in the point cloud. Not all embodiments include removing at least one of the detected clusters. For example, in a point cloud that is already of sufficient quality, a sufficient number of points may be eliminated simply by removing triangle edges and all of the resulting clusters may be retained. In these embodiments, the points would have been filtered but no clusters would have been removed.

One or more aspects of the subject disclosure include a method comprising triangulating, by a processing system including a processor, a set of data points in a point cloud to form a set of triangles, wherein each triangle in the set of triangles includes edges and vertices; removing, by the processing system, one or more edges from the set of triangles based on one or more properties of each triangle in the set of triangles to produce a filtered set of triangles; detecting, by the processing system, one or more clusters of data points to produce detected clusters, wherein each cluster of the detected clusters comprises data points connected by edges of the filtered set of triangles; and removing, by the processing system, at least one of the detected clusters based on one or more cluster properties, resulting in a final set of clusters representing likely real objects in the point cloud. Not all embodiments include removing at least one of the detected clusters. For example, in a point cloud that is already of sufficient quality, a sufficient number of points may be eliminated simply by removing triangle edges and all of the resulting clusters may be retained. In these embodiments, the points would have been filtered but no clusters would have been removed.

The LIDAR system may further analyze the properties of each triangle in the set of triangles, such as the distance of the triangle from the LIDAR system, to refine the filtered set of triangles. For example, the system may normalize edge lengths based on the distance from the LIDAR sensor, allowing for longer edge lengths as the points get farther away.

The detected clusters may be filtered based on intrinsic properties, such as the number of data points in each cluster, or the volume occupied by each cluster. For instance, clusters with too few points or an implausibly large volume may be discarded as noise. The detected clusters may also be filtered based on extrinsic properties, such as a distance from the LIDAR sensor or a distance from other clusters.

The operations may further include adjusting the field of view of the LIDAR system based on the spatial distribution of the detected clusters. For example, the system may narrow the field of view to focus on regions of interest identified by the clusters.

The resolution of the LIDAR system may be dynamically adjusted based on the spatial distribution of the detected clusters. For instance, the system may increase the resolution in areas where clusters indicate the presence of real objects.

The triangulation process may employ Delaunay triangulation to form the set of triangles, which may avoid sliver (e.g., tall and skinny) triangles that could compromise the analysis.

Alternatively, the triangulation process may use other types of triangulation to form the set of triangles, providing a different structured framework for analyzing relationships between data points. For example, the triangulation process may use polygon triangulation.

The operations may further include normalizing the lengths of the edges in the point cloud based on their distance from the LIDAR system, such that edges farthest from the LIDAR system are reduced. This normalization may capture any meaningful relationships that exist across varying distances.

In some embodiments, the operations may involve modifying the power of the laser light source in the LIDAR system based on at least one property of the final set of clusters. For example, the system may increase the laser power in regions identified as areas of interest.

The scanning trajectory components of the LIDAR system may be adjusted based on at least one property of the final set of clusters. For instance, the system may modify the angular velocity of scanning mirrors to focus on regions of interest.

The resolution of the LIDAR system may be adjusted based on at least one property of the final set of clusters. For example, the system may increase the resolution in areas where clusters indicate the presence of real objects.

The edge lengths of each triangle in the set of triangles may be normalized based on distances from the LIDAR sensor to produce normalized edge lengths. The removal of edges from the set of triangles may then be based on these normalized edge lengths, providing meaningful relationships across varying distances.

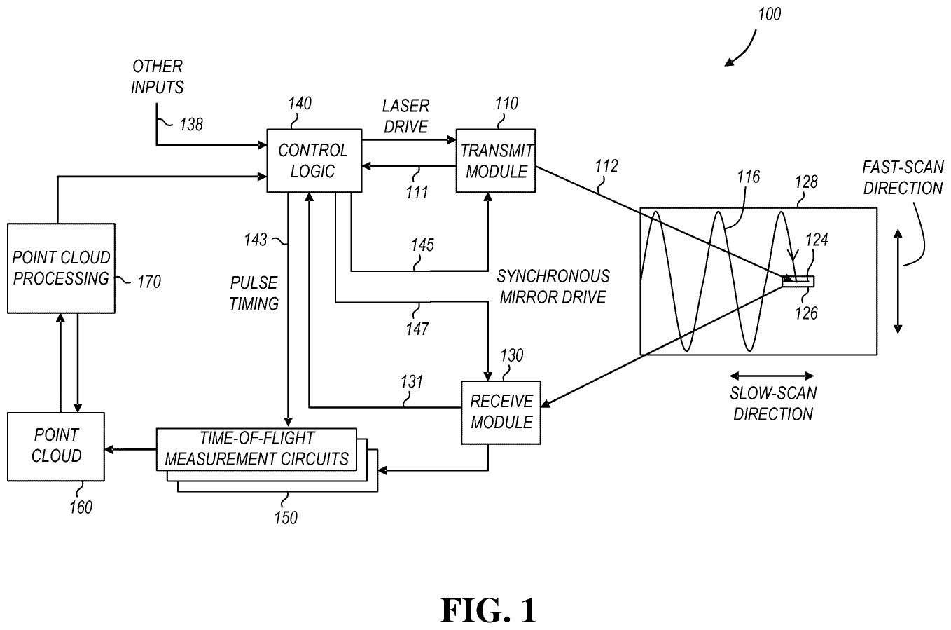

FIG. 1 shows a LIDAR system with scanning mirror assemblies in accordance with various aspects described herein. System 100 includes control circuit 140, transmit module 110, receive module 130, time-of-flight (TOF) measurement circuits 150, point cloud storage device 160, and computer vision processing 170.

Transmit module 110 emits a scanning pulsed laser beam 112 that traverses a field of view 128 in two dimensions. In some embodiments, the scanning pulsed laser beam is collimated into a point beam. Further, in some embodiments, the scanning pulsed laser beam 112 is a fanned beam. The shape of the fanned beam is shown at 124, and the scanning trajectory that the pulsed laser beam takes through the field of view is shown at 116. In some embodiments, to produce the scanning pulsed fanned beam, transmit module 110 includes a laser light source to produce a pulsed laser beam, collimating and focusing optics to shape the pulsed laser beam into a pulsed fanned laser beam, and one or more scanning mirror assemblies to scan the pulsed fanned laser beam in two dimensions in the field of view. Example embodiments of transmit modules are described more fully below with reference to later figures.

In some embodiments, receive module 130 includes an arrayed receiver that includes a plurality of light sensitive devices. Receive module 130 also includes optical devices and one or more scanning mirror assemblies to scan in two dimensions and to direct reflected light from the field of view to the arrayed receiver. As shown in FIG. 1, receive module 130 captures reflected light from an aperture 126 that encompasses the location of the fanned beam in the field of view. Example embodiments of receive modules are described more fully below with reference to later figures.

The reflected fanned beam becomes “discretized” by the array of light sensitive devices, and the corresponding points in the field of view from which the beam is reflected are referred to herein as “measurement points.”

As used herein, the term “fanned beam” refers to a beam of light that has been purposely shaped to encompass more measurement points in one dimension than in another dimension. For example, as shown in FIG. 1, fanned beam 112 includes shape 124 that encompasses more measurement points in the horizontal dimension than in the vertical dimension. Although fanned beam embodiments are further described below, the subject matter described herein is not limited to fanned beam embodiments. For example, in some embodiments, the scanning pulsed laser beam 112 may be a collimated beam that is not fanned in either dimension.

Time-of-flight (TOF) measurement circuits 150 are each coupled to one of the light sensitive devices in the arrayed receiver to measure a time-of-flight of a laser pulse. TOF measurement circuits 150 receive laser light pulse timing information 143 from control logic 140 and compare it to the timing of received laser light pulses to measure round trip times-of-flight of light pulses, thereby measuring the distance (Z) to the point in the field of view from which the laser light pulse was reflected. Accordingly, TOF measurement circuits 150 measure the distance between LIDAR system 100 and measurement points in the field of view at which light pulses from the scanned fanned beam are reflected.

TOF measurement circuits 150 may be implemented with any suitable circuit elements. For example, in some embodiments, TOF measurement circuits 150 include digital and/or analog timers, integrators, correlators, comparators, registers, adders, or the like to compare the timing of the reflected laser light pulses with the pulse timing information received from control logic 140.

Point cloud storage 160 receives TOF information corresponding to distance (Z) information from TOF measurement circuits 150. In some embodiments, the TOF measurements are held in point cloud storage 160 in an array format such that the location within point cloud storage 160 indicates the location within the field of view from which the measurement was taken. In other embodiments, the TOF measurements held in point cloud storage 160 include (X, Y) position information as well as TOF measurement information to yield (X, Y, Z) as a three-dimensional (3D) data set that represents a depth map of the measured portion of the field of view 128. In further embodiments, the point cloud data may include additional dimensions beyond three, such as intensity (I) representing the strength of the reflected signal, timestamp (T) indicating the time of measurement, or color information (R, G, B) representing the red, green, and blue channels of the reflected light. These higher-dimensional data sets enable more sophisticated analyses, such as distinguishing between materials based on reflectivity, tracking temporal changes in the environment, or performing detailed object classification. The point cloud data may then be used for any suitable purpose, including 3D imaging, velocity field estimation, object recognition, adaptive field of view modifications, and the like.

Point cloud storage 160 may be implemented using any suitable circuit structure. For example, in some embodiments, point cloud storage 160 is implemented in a dual port memory device that can be written on one port and read on a second port. In other embodiments, point cloud storage 160 is implemented as data structures in a general purpose memory device. In still further embodiments, point cloud storage 160 is implemented in an application specific integrated circuit (ASIC).

In some embodiments, point cloud processing 170 performs analysis on the point cloud data and provides feedback to control logic 140. For example, in some embodiments, point cloud processing 170 performs filtering of data points in the point cloud, object identification, classification, and tracking within the field of view, and provides this information to control logic 140. Point cloud processing 170 may take any form, including a general purpose processor and memory, dedicated digital hardware such as application specific integrated circuits (ASICs), neural networks of any depth, convolutional neural nets, traditional vision processing methods, and the like.

Control logic 140 determines laser drive properties and drives transmit module 110 with signal(s) that cause the light source to emit laser light pulses having the specified properties. For example, control logic 140 may determine values for laser drive power, pulse rate, pulse width, and number of multishot pulses. Further, control logic 140 may adaptively modify the laser drive properties in response to feedback from computer vision processing 170 or in response to other inputs 138.

Control logic 140 also controls the movement of scanning mirrors within transmit module 110 and receive module 130. In operation, control logic 140 receives mirror position feedback information 111 from transmit module 110, and also receives mirror position feedback information 131 from receive module 130. The mirror position feedback information is used to phase lock the operation of the mirrors. Control logic 140 drives microelectromechanical (MEMS) assemblies with scanning mirrors within transmit module 110 with drive signal(s) 145 and also drives MEMS assemblies with scanning mirrors within receive module 130 with drive signal(s) 147 that cause the mirrors to move non-resonantly through angular extents of mirror deflection with angular offsets that define the size and location of field of view 128. Control logic 140 synchronizes the movement between mirrors in transmit module 110 and receive module 130 so that area 126 is continually positioned in the field of view to receive light reflected from objects that are illuminated with pulsed fanned beam 112. The synchronization of transmit and receive scanning allows the receive aperture to only accept photons from the portion of the field of view where the transmitted energy was transmitted. This results in significant ambient light noise immunity.

In some embodiments, control logic 140 is implemented using functional circuits such as phase lock loops (PLLs), filters, adders, multipliers, registers, processors, memory, and the like. Accordingly, control logic 140 may be implemented in hardware, software, or in any combination. For example, in some embodiments, control logic 140 is implemented in an application specific integrated circuit (ASIC). Further, in some embodiments, some of the faster data path control is performed in an ASIC and overall control is software programmable.

As shown in FIG. 1, the two dimensional scanning is performed in a first dimension (vertical, fast scan direction) and a second dimension (horizontal, slow scan direction). The labels “vertical” and “horizontal” are somewhat arbitrary, since a 90 degree rotation of the apparatus will switch the horizontal and vertical axes. Accordingly, the terms “vertical” and “horizontal” are not meant to be limiting.

The scanning trajectory in the fast scan direction is shown as sinusoidal, and the scanning trajectory in the slow scan direction is shown as constant velocity, although this is not a limitation. In some embodiments, all mirror motion is operated non resonantly. Accordingly, a relatively flat control band may exist down to and including 0 Hz. This allows a drive signal to be generated to cause the pointing angle (boresight) of the LIDAR system to deflect to a desired position in two dimensions (azimuth & elevation) of a spherical coordinate space, offset from the mirror relaxation point.

The angular extents of mirror deflection of both the transmit and receive modules can be adjusted to change the active field of view of the LIDAR system. The scanning mirror assemblies are designed for reliable operation at some maximum angle of deflection along each scan axis. From that nominal/max operating point, the drive amplitude may be reduced to collapse the deflection angle and narrow the active field of view. All else being equal, this results in a proportional increase in the angular resolution of the acquired scene.

In some embodiments, it is beneficial to trade off surplus angular resolution for increased range of measurement. For example, reducing the pulse repetition rate allows for a longer flight time in between adjacent pulses, eliminating range aliasing out to a proportionally larger distance. Accordingly, a balance exists such that reducing the field of view increases the non-ambiguous range of the LIDAR system without changing the angular resolution of the acquired scene. In some embodiments, laser power modifications are performed as a complement to increased range. For example, the laser power may be scaled as the square of the proportional increase in range.

Though the scanned field of view, pulse repetition rate, and laser power may all be independently controlled by software configuration, in some embodiments, it may be desirable to also design them to be commanded in a coordinated manner, automatically under hardware control.

Pulse width may also be controlled in the same manner in order to augment the scaled distance of interest. As the pulse width is increased, additional energy is deposited into the scene, increasing the likelihood of a sufficient number of photons returning to the receiver to trip the detection threshold. In some embodiments, increasing the pulse width is only performed when the peak power is maxed out as a wider pulse increases time resolution error for weak returns. This tradeoff is often warranted and useful as absolute time/distance resolution is typically not as important as percentage error which self-normalizes with distance.

Pulse energy may also be augmented by means of a train of shorter multishot pulses. The number of pulses may be varied to achieve the desired amount of energy in addition to or in place of modification of the pulse width.

Various embodiments of point cloud processing 170 described herein utilize a process of triangulation, edge removal, and cluster filtering to enhance the accuracy and reliability of the point cloud data stored in the point cloud storage 160 of FIG. 1. In some embodiments, the LIDAR system 100 generates a raw set of data points representing the environment, which are stored in the point cloud storage 160. These data points may include both meaningful reflections from real objects and noise caused by environmental factors such as ambient light. Various embodiments address the challenge of distinguishing real data points from noise with an acceptable level of probability, providing a stored point cloud data that accurately reflects the sensed environment.

In various embodiments, the process begins with the triangulation of the raw data points in the point cloud. In some embodiments, Delaunay triangulation may be employed to create a network of edges connecting the data points. Delaunay triangulation is effective in part because it avoids sliver triangles, creating uniformity in the shape of triangles and improving the algorithm's effectiveness. This triangulated representation forms the basis for subsequent filtering steps, as it provides a structured framework for analyzing relationships between data points.

Once the triangulation is complete, some embodiments described herein remove edges based on intrinsic and/or extrinsic properties. Intrinsic properties may include edge length, angles between vertices, and the area of triangles formed by the edges. Extrinsic properties may include other properties such as the distance of the points from the LIDAR sensor. In some embodiments, edge lengths are normalized based on their distance from the sensor, allowing for longer edge lengths as the points get farther away. This normalization accounts for the spatial distribution of the data points, removing edges that do not represent meaningful relationships.

The removal of edges results in clusters of data points connected by the remaining edges. In various embodiments, a cluster is defined as a set of points connected through one or more edges, meaning any two points in the cluster can be reached by traversing the edges. The system may identify clusters by grouping vertices connected through a series of edges. This step isolates regions of the point cloud that are more likely to represent real objects, as opposed to noise or other unwanted artifacts.

The clusters are then filtered based on intrinsic and/or extrinsic properties, such as the number of points in the cluster, the volume occupied by the cluster, and/or the distance from the sensor. Clusters that do not meet certain thresholds may be removed, leaving only those that are likely to represent real objects. For example, clusters with too few points or an implausibly large volume may be discarded as noise. This filtering process further refines the data, such that the final point cloud consists of meaningful clusters. Not all embodiments include removing of detected clusters. For example, in a point cloud that is already of sufficient quality, a sufficient number of points may be eliminated simply by removing triangle edges and all of the resulting clusters may be retained. In these embodiments, the points would have been filtered but no clusters would have been removed.

In some embodiments, the filtered point cloud is stored in the point cloud storage 160, where it serves as a reliable representation of the sensed environment. In some embodiments, the filtered point cloud includes three-dimensional (3D) data sets with (X, Y, Z) coordinates (or higher dimensionality data sets as described herein), forming a depth map of the measured portion of the field of view. This refined data can be used for various applications, including object detection, environmental mapping, and adaptive scanning. By removing noise and retaining meaningful data, the embodiments described herein significantly improve the quality of the point cloud stored in the point cloud storage 160.

In some embodiments, the spatial distribution of the detected clusters can be used to adjust the field of view or resolution of the LIDAR system. For example, the system may focus on regions of interest identified by the clusters to gather higher-density information. Additionally, various embodiments may modify the power output of the LIDAR system based on the properties of the final clusters. For example, if a cluster is identified as an area of interest, the system may increase the laser pulse repetition rate or adjust the scanning trajectory to enhance data acquisition in that region. These dynamic modifications provide efficient LIDAR system operation while maintaining high-resolution data where desired in the field of view. These adaptive capabilities provide practical applications of the point cloud filtering algorithm resulting in improved LIDAR system performance. These and other embodiments are described further below with reference to later figures.

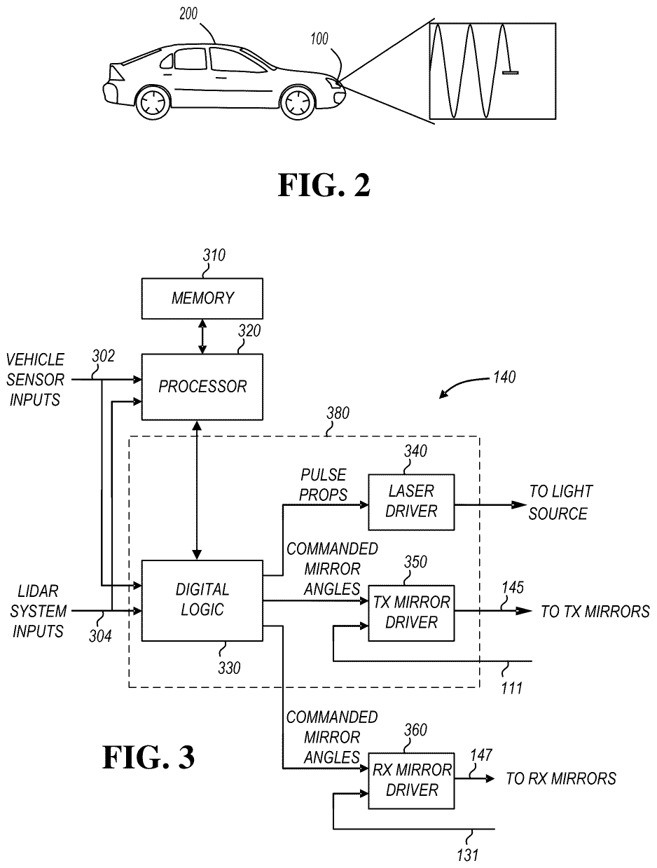

FIG. 2 shows an automotive application of a LIDAR system with scanning mirror assemblies in accordance with various aspects described herein. As shown in FIG. 2, vehicle 200 includes LIDAR system 100 at the front of the vehicle. LIDAR system 100 synchronously scans transmit and receive scanning mirrors such that receiver aperture 126 substantially overlaps the shape 124 of the pulsed fanned beam. Although much of the remainder of this description describes the LIDAR system in the context of an automotive application, the various embodiments described herein are not limited in this respect.

FIG. 3 shows a block diagram of a control logic in accordance with various aspects described herein. The example embodiment shown in FIG. 3 corresponds to a control logic that may be included when LIDAR system 100 is used in an automotive application. Other control logic embodiments may be employed when used in applications other than automotive applications. Control logic 140 includes processor 320, memory 310, transmit control circuitry 380, and receive mirror driver 360. Transmit drive circuitry includes digital logic 330, laser driver 340, and transmit mirror driver 350. Control logic 140 receives vehicle sensor inputs at 302 and LIDAR system inputs at 304. Vehicle sensor inputs may include any type of data produced by sensors on a vehicle. Examples include data describing vehicle position, speed, acceleration, direction. Other examples include sensor data received from adaptive driver assistance systems (ADAS) or other vehicle mounted sensors. LIDAR system inputs may include any data gathered or produced by the LIDAR system. Examples include computer vision processing results, internal inertial measurement unit data, and the like.

Processor 320 may include any type of processor capable of executing instructions stored in a memory device. For example, processor 320 may be a microprocessor, a digital signal processor, or a microcontroller. Processor 320 may also be a hard-coded processor such as a finite state machine that provides sequential flow control without fetching and executing instructions.

Memory 310 may be any device that stores data and/or processor instructions. For example, memory 310 may be a random access memory device that stores data. In some embodiments, memory 310 is a non-transitory storage device that stores instructions, that when accessed by processor 320 result in processor 320 performing actions. For example, in some embodiments, processor 320 executes instructions stored in memory 310 and performs method embodiments.

Digital logic 330 receives vehicle sensor inputs at 302 and LIDAR system inputs at 304 and outputs information used to control a laser light source and scanning mirrors. Digital logic 330 may produce the outputs based solely on the vehicle sensor data and/or LIDAR system data, may produce the outputs based solely on interactions with processor 320, or may produce the outputs based on a combination of the vehicle sensor data, LIDAR system data, and interaction with processor 320. For example, in some embodiments, digital logic 330 modifies laser light pulse parameters such as pulse power, repetition rate, pulse width, and number of multishot pulses in response to vehicle sensor data and/or LIDAR system data such as retained clusters. Also for example, in some embodiments, digital logic 330 modifies angular extents and angular offsets used to drive the scanning mirrors in the transmit module and receive module in response to vehicle sensor data and/or LIDAR system data.

In some embodiments, digital logic 330 provides output data under software control via interaction with processor 320. For example, processor 320 may determine values for any of the outputs in response to vehicle sensor data and/or LIDAR system data, and then command digital logic under software control. In other embodiments, digital logic 330 may provide output data under hardware control independent of processor 320. For example, an adaptive model may be programmed into digital logic 330 in advance, and digital logic 330 may then modify outputs as a function vehicle sensor data and/or LIDAR system data at a much faster rate.

Laser driver 340 receives laser light properties from digital logic 330 and drives the laser light source. For example, laser driver 340 may receive property values for pulse power, pulse repetition rate, pulse width, and number of multishot pulses, and produce an analog signal to drive a laser light source. Laser driver 340 may be implemented with any suitable circuit elements including for example, high speed signal generators, amplifiers, filters, and the like.

Mirror drivers 350, 360 receive commanded mirror angle information from digital logic 330 and mirror position feedback information 111, 131, and produce drive signals 145, 147 to cause scanning mirrors in modules 110, 130 to undergo motion. Transmit mirror driver 350 and receive mirror driver 360 may be implemented using any suitable circuit structures including for example, phase lock loops, numerically controlled oscillators, filters, amplifiers, and the like. In some embodiments, mirror position feedback information 111, 131 includes measured mirror angle information as well as measured temperature information. Mirror drivers use the measured temperature information to compensate for angle measurement errors as a function of temperature. These and other embodiments are further described below.

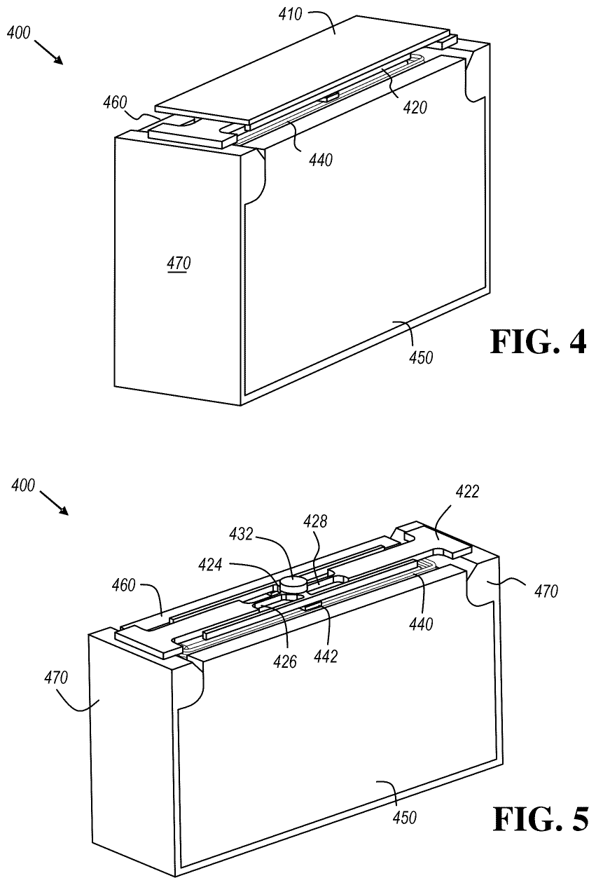

FIG. 4 shows a scanning mirror assembly and FIG. 5 shows the scanning mirror assembly with the mirror removed in accordance with various aspects described herein. Scanning mirror assembly 400 may be used to implement any of the scanning mirror assemblies described herein. For example, any of scanning mirror assemblies 1030, 1040, 1230, and 1240 described below may be implemented with scanning mirror assembly 400.

Scanning mirror assembly 400 includes mirror 410, Microelectromechanical system (MEMS) device 420, conductive coil 440, magnetically permeable components 450, 460, and housing 470. MEMS device 420 includes fixed platforms 422 and scanning platform 424. Scanning platform 424 is coupled to fixed platforms 422 by flexures 426, 428. Mirror 410 is affixed to scanning platform 424 by adhesive 432. Fixed platforms 422 are affixed to housing 470.

The axis of flexures 426, 428 forms a pivot axis. Flexures 426, 428 are flexible members that undergo a torsional flexure, also referred to herein as torsional movement, thereby allowing scanning platform 424 to rotate on the pivot axis and have an angular displacement relative to fixed platforms 422. Flexures 426, 428 are not limited to torsional embodiments as shown in FIG. 5. For example, in some embodiments, flexures 426, 428 take on other shapes such as arcs, “S” shapes, or other serpentine shapes.

MEMS device 420 also incorporates a plurality of piezoresistive strain sensors. In some embodiments, the plurality of piezoresistive strain sensors are positioned on or near one of flexures 426, 428 to produce a voltage that represents the angular displacement of scanning platform 424 with respect to fixed platforms 422. The piezoresistive sensor(s) are coupled to electrical contacts (not shown) on fixed platforms 422 so that position feedback signal(s) may be provided to control logic 140 (FIGS. 1, 3).

Much of MEMS device 420 can be fabricated from a single common substrate using MEMS techniques. For example, the fixed platforms 422, the scanning platform 424 and the two flexures 426, 428 can all be formed from the same substrate. Additionally, in some embodiments, conductive signal traces, contacts, and piezoresistive strain sensors can also be formed with any suitable MEMS technique. For example, the signal traces, contacts, and piezoresistive strain sensors can be formed by the selective deposition and patterning of conductive materials on the substrate.

Scanning mirror assembly 400 also includes a conductive coil 440 affixed to the underside of scanning platform 424 by adhesive 442. In operation, a current is induced in conductive coil 440 to create a magnetic field. The interaction of the magnetic field produced by conductive coil 440 with a magnetic field produced by one or more permanent magnets (not shown in FIGS. 4, 5) creates Lorentz forces on scanning platform 424 and results in an angular displacement of mirror 410 as a function of drive current in conductive coil 440.

Housing 470 may be made of any suitable material. For example, in some embodiments, housing 470 is plastic. Fixed platforms 422 may be affixed to housing 470 using any suitable technique, including fasteners or adhesive.

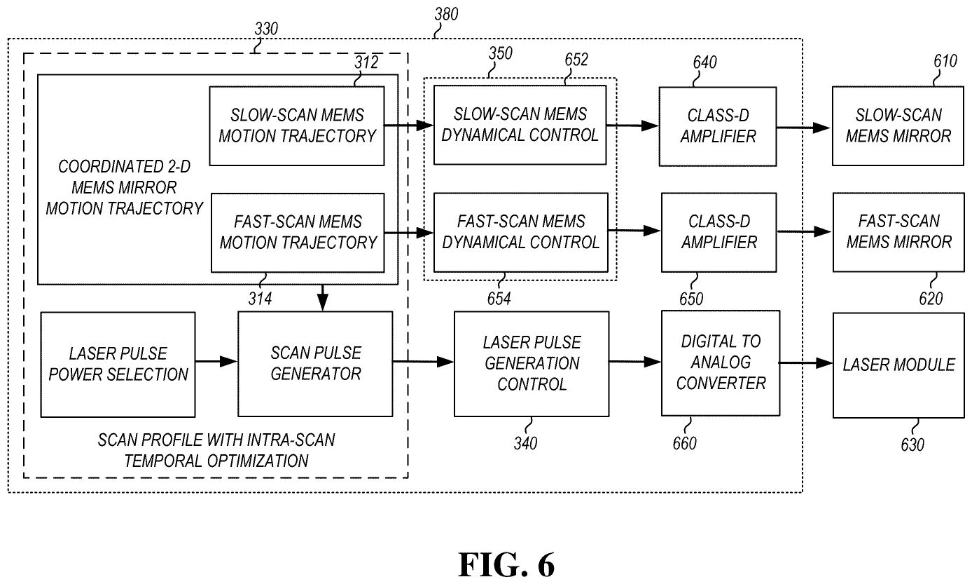

FIG. 6 shows a block diagram of transmit drive circuitry, scanning mirrors, and a laser module in accordance with various aspects described herein. The transmit drive circuitry 380 is responsible for generating the 2-dimensional MEMS mirror motion trajectory, which includes both the horizontal mirror motion trajectory and the vertical mirror motion trajectory. Various embodiments produce scan trajectories that may enhance the resolution of the LIDAR system.

Slow-scan MEMS mirror 610 reflects laser light pulses received from laser module 630 and scans the received laser light pulses on a slow scan axis. Similarly, fast-scan MEMS mirror 620 reflects the laser light pulses and scans the received laser light pulses on a fast scan axis. In some embodiments, slow-scan MEMS mirror 610 reflects laser light pulses received from laser module 630, and fast-scan MEMS mirror 620 reflects laser light pulses received from slow-scan MEMS mirror 610. In other embodiments, fast-scan MEMS mirror 620 reflects laser light pulses received from laser module 630, and slow-scan MEMS mirror 610 reflects laser light pulses received from fast-scan MEMS mirror 620. Slow-scan MEMS mirror 610 and fast-scan MEMS mirror 620 may be implemented using any suitable MEMS mirror design, including for example, scanning mirror assembly 400 (FIGS. 4, 5).

Transmit mirror driver 350 includes slow-scan MEMS dynamical control 652 and fast-scan MEMS dynamical control 654. The slow-scan MEMS mirror 610 and the fast-scan MEMS mirror 620 are driven by the slow-scan MEMS dynamical control 652 and the fast-scan MEMS dynamical control 654, respectively. These controls receive digital signals from the digital logic 330 and convert them into analog signals to drive the MEMS mirrors. The laser module 630 generates laser light pulses in response to a drive signal received from laser driver 340, and laser driver 340 produces the drive signal in response to control signal(s) received from digital logic 330.

In some embodiments, one or more of the slow-scan mirror motion trajectory 312 and the fast-scan mirror motion trajectory 314 are generated using a look up table. For example, the desired trajectory may be represented as a sequence of discrete points that are stored in a memory device (look up table) and the contents are read out in sequence and converted to analog form by transmit mirror driver 350. In other embodiments, one or more of the slow-scan mirror motion trajectory 312 and the fast-scan mirror motion trajectory 314 are generated by summing sinusoidal signals. For example, in some embodiments, odd harmonics are summed with a fundamental to create the fast scan and/or slow scan trajectory component.

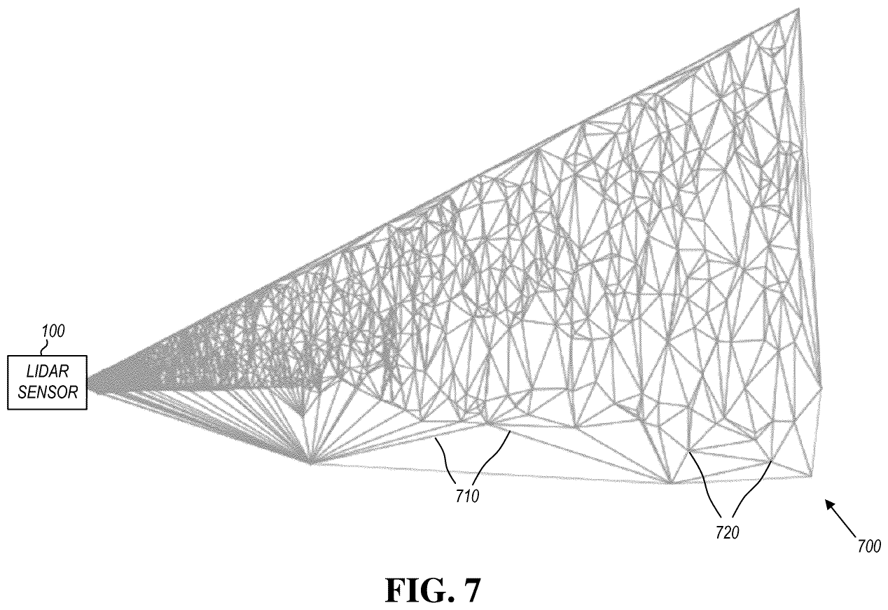

FIG. 7 shows triangulation of a set of data points 700 in a point cloud in accordance with various aspects described herein. As described above, these data points are generated by the LIDAR sensor 100, which measures distances to objects in the environment using time-of-flight measurements. Each data point in the point cloud corresponds to a vertex 720 in the diagram, representing a specific location in three-dimensional space.

The triangulation shown in FIG. 7 may be performed by point cloud processing 170, which analyzes the set of data points stored in the point cloud storage device 160. Point cloud processing 170 connects the vertices 720, corresponding to the data points, with edges 710, forming a structured network of triangles that represent the spatial relationships between the data points. In some embodiments, point cloud processing 170 may include storage to hold the filtered data points after processing, ensuring that the refined data is readily accessible for further analysis or application. Alternatively, point cloud processing 170 may return the filtered data points back into the point cloud storage device 160, updating the stored point cloud with the refined representation of the sensed environment.

In some embodiments, the operations represented by FIG. 7 may be performed using a processor that executes instructions retrieved from a non-transitory machine-readable medium. For example, a processor may execute instructions retrieved from random access memory (RAM) or flash storage, to perform the triangulation operations shown in FIG. 7. In other embodiments, the operations represented by FIG. 7 may be performed using specialized hardware, such as application-specific integrated circuits (ASICs), to perform these operations with enhanced speed and efficiency.

In some embodiments, the triangulation shown in FIG. 7 is performed using Delaunay triangulation, which is particularly effective for creating triangles that are as equilateral as possible. Delaunay triangulation avoids sliver triangles, creating a uniform and robust structure for use in subsequent processing steps. For example, Delaunay triangulation may be used to maximize the minimum angle of all triangles in the network, reducing the likelihood of poorly shaped triangles that could compromise the analysis. Other triangulation methods, such as polygon triangulation or constrained triangulation, may also be employed. Any type of triangulation method may be performed without departing from the scope of the various embodiments described herein.

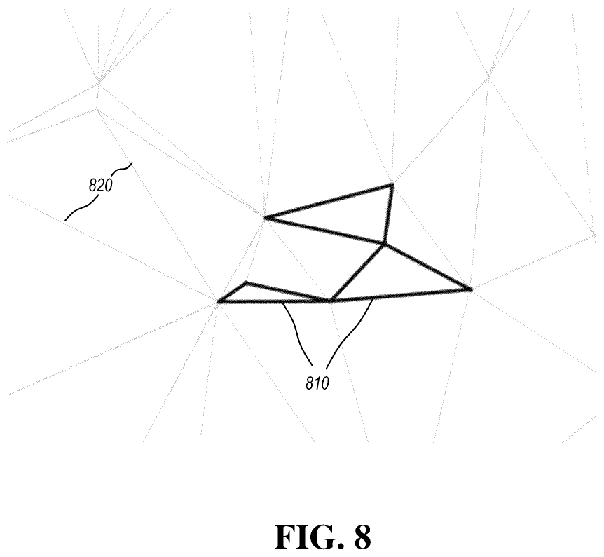

In some embodiments, the lengths of the edges 710 are normalized based on their distance from the LIDAR sensor 100 to account for the spatial distribution of the data points. This normalization allows for longer edge lengths as the points get farther away, allowing the triangulation to remain meaningful across varying distances. Intrinsic properties, such as edge length and angles between vertices, and extrinsic properties, such as the distance of the points from the sensor, are analyzed to determine which edges should be retained. This is further described below with reference to FIG. 8.

While FIG. 7 provides a 3D representation of the set of data points in the point cloud, the triangulation process is generalizable to N-dimensions. For example, in some embodiments, additional data or properties are included with each data point in the point cloud and this additional data may be included in the triangulation such that the triangles are created in 4D, 5D, or higher dimensional space. Additionally, in some embodiments (e.g., Delaunay triangulation embodiments), the algorithm operates in linear time, i.e., O(N), providing for computational efficiency even for large point clouds.

FIG. 8 shows a cluster of data points and removed edges in accordance with various aspects described herein. FIG. 8 illustrates the process of edge removal in a portion of a triangulated representation of a point cloud, as performed by point cloud processing 170. The figure shows retained edges 810 and removed edges 820, which are part of the structured network of triangles formed during the triangulation process described with respect to FIG. 7.

The retained edges 810 represent connections between vertices that satisfy certain intrinsic and/or extrinsic properties, such as edge length, angles between vertices, and/or distance from the LIDAR sensor. To account for the spatial distribution of the data points, edge lengths are normalized based on their distance from the LIDAR sensor. This normalization allows for longer edge lengths as the points get farther away, allowing the edge removal process to provide meaningful relationships between vertices across varying distances. For example, shorter edges or edges forming equilateral triangles may be retained to preserve the structural integrity of the triangulated representation.

The removed edges 820, shown in gray, represent connections that do not meet the required criteria and are excluded from the filtered set of triangles. These edges may be removed based on intrinsic properties, such as excessive length or irregular angles, and extrinsic properties, such as the distance of the points from the LIDAR sensor. For example, edges connecting vertices that are too far apart or that form highly skewed triangles may be discarded to eliminate noise and improve the accuracy of the point cloud representation.

Once the edge removal process is complete, the retained edges 810 are used to identify clusters of data points. A cluster is defined as a set of vertices connected through one or more retained edges, meaning any two points in the cluster can be reached by traversing the retained edges. The identification of clusters involves grouping vertices based on their connectivity through the retained edges, isolating regions of the point cloud that are more likely to represent real objects. The resulting filtered point cloud includes a meaningful set of clusters, which serve as the foundation for further refinement and analysis.

In FIG. 8, the retained edges 810, shown in black, represent a single cluster of data points. These edges connect vertices that are spatially related and satisfy the criteria for meaningful relationships, such as appropriate edge lengths and angles. By virtue of the connectivity of the retained edges, all vertices within the cluster are reachable by traversing the edges, forming a cohesive group. For example, the vertices connected by the retained edges 810 may represent points on the surface of a real object detected by the LIDAR sensor. The structure formed by the retained edges 810 provides a reliable representation of the spatial relationships within the cluster, distinguishing it from noise or unrelated data points.

This single cluster, as illustrated by the retained edges 810, serves as an example of how the edge removal and clustering process isolates regions of the point cloud that are likely to correspond to real objects. By focusing on the connectivity of retained edges, point cloud processing 170 provides a filtered point cloud that accurately reflects the sensed environment and that is ready for further analysis, such as object recognition or adaptive scanning.

By removing edges that do not represent significant connections and identifying clusters using the retained edges, point cloud processing 170 refines the triangulated representation, leaving a filtered set of clusters that better reflects the sensed environment. These clusters provide a reliable basis for subsequent processing steps, such as object recognition or adaptive scanning.

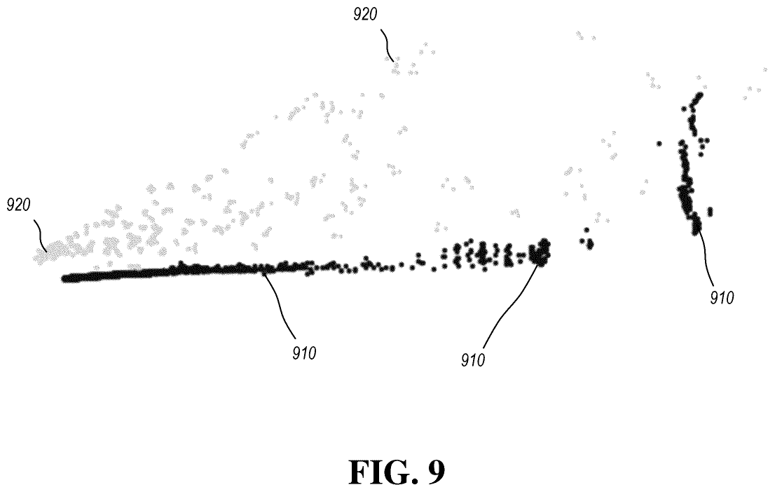

FIG. 9 shows removed clusters and a final set of clusters in accordance with various aspects described herein. FIG. 9 illustrates the results of the clustering process performed by point cloud processing 170, showing retained clusters 910 and removed clusters 920. The retained clusters 910, shown in black, represent groups of data points that are likely to correspond to real objects in the sensed environment. In some embodiments, these clusters may be identified based on the connectivity of retained edges, as described in FIG. 8, and satisfy one or more intrinsic and/or extrinsic properties. For example, intrinsic properties may include the number of points in the cluster, the volume occupied by the cluster, the spatial distribution of the points, and the like. Also for example, extrinsic properties may include the distance of the cluster from the LIDAR sensor, which helps distinguish meaningful clusters from noise caused by environmental factors such as ambient light.

The removed clusters 920, shown in gray, represent groups of data points that do not meet specific thresholds for intrinsic and/or extrinsic properties and are excluded from the final filtered point cloud. For example, clusters with too few points, an implausibly large volume, or irregular spatial distributions may be discarded as noise. Additionally, clusters located at distances that suggest they are artifacts rather than meaningful reflections from real objects may be removed. As a result of this filtering process, the retained clusters 910 include cohesive groups of data points that are spatially related and meet the criteria for meaningful relationships. Not all embodiments include removing at least one of the detected clusters. For example, in a point cloud that is already of sufficient quality, a sufficient number of points may be eliminated simply by removing triangle edges and all of the resulting clusters may be retained. In these embodiments, the retained clusters 910 includes all of the detected clusters.

The retained clusters 910 form the final filtered point cloud, which provides a reliable representation of the sensed environment. For example, the retained clusters 910 may correspond to surfaces of objects detected by the LIDAR sensor, such as vehicles, buildings, roads, fences, trees, or other environmental features. By isolating these meaningful clusters, the filtering process enhances the accuracy and reliability of the point cloud data.

In some embodiments, the filtered clusters are used to dynamically adjust the resolution or field of view of the LIDAR system. For example, the system may focus on areas of interest identified by the retained clusters 910 to gather higher-density information. Additionally, the properties of the retained clusters may be used to modify the power output or scanning trajectory of the LIDAR system, providing efficient operation while maintaining high-resolution data in critical areas.

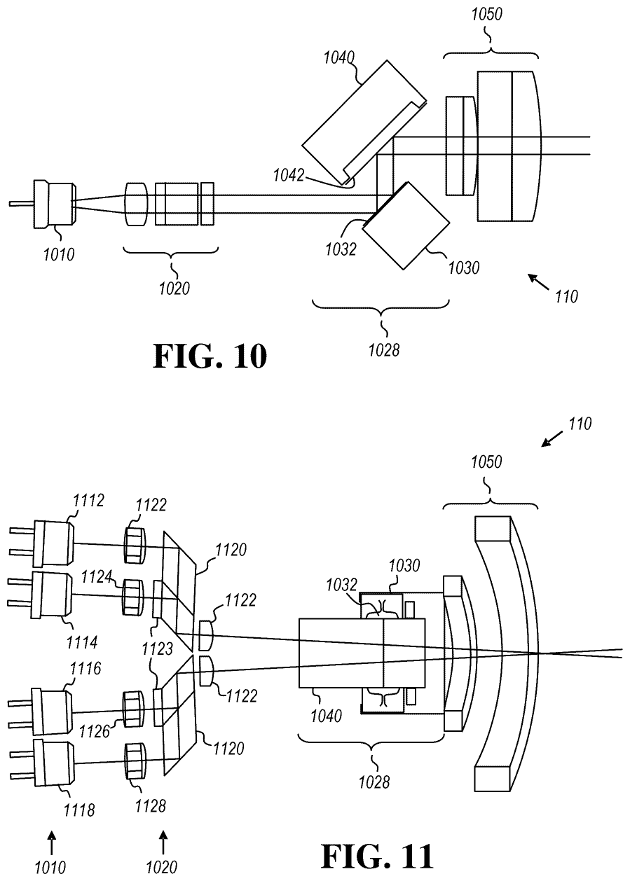

FIG. 10 shows a side view and FIG. 11 shows a top view of a transmit module in accordance with various aspects described herein. Transmit module 110 includes laser light source 1010, beam shaping optical devices 1020, scanner 1028, and exit optical devices 1050.

In some embodiments, laser light source 1010 sources nonvisible light such as infrared (IR) light. In these embodiments, the receive module 130 (FIG. 1) is able to detect the same wavelength of nonvisible light. For example, in some embodiments, light source 1010 may include a laser diode that produces infrared light with a wavelength of substantially 905 nanometers (nm), and receive module 130 detects reflected light pulses with a wavelength of substantially 905 nm. Also for example, in some embodiments, light source 1010 may include a laser diode that produces infrared light with a wavelength of substantially 940 nanometers (nm) and receive module 130 detects reflected light pulses with a wavelength of substantially 940 nm. The wavelength of light is not a limitation of the various embodiments. Any wavelength, visible or nonvisible, may be used without departing from the scope of the various embodiments described herein.

Laser light source 1010 may include any number or type of emitter suitable to produce a pulsed fanned laser beam. For example, in some embodiments, laser light source 1010 includes multiple laser diodes shown in FIG. 11 at 1112, 1114, 1116, and 1118. In some embodiments, the pulsed laser light produced by laser light source 1010 is combined, collimated, and focused by beam shaping optical devices 1020 to produce a pulsed fanned laser beam. For example, optical devices 1122 may collimate the laser beams on the fast axis, polarization rotators 1123 and beam combiners 1120 may combine laser beams, and optical devices 1122 may form the pulsed laser beam into a fan on the slow axis. In some embodiments, the pulsed laser beam may be focused to form the fanned beam, and in other embodiments, the pulsed laser beam may be expanded to form the fanned beam. In some embodiments, optical devices 1122 may be line generator optics to form the pulsed laser beam into a fanned beam. In some embodiments, the pulsed laser beam may be collimated on the fast axis with <0.2 degrees of divergence and may be focused or expanded on the slow axis to diverge at a rate that produces a fan of substantially four degrees. Beam sizes and divergence values are not necessarily uniform across the various embodiments described herein; some embodiments have higher values, and some embodiments have lower values.

Scanner 1028 receives the pulsed fanned laser beam from optical devices 1020 and scans the pulsed fanned beam in two dimensions. In embodiments represented by FIGS. 10 and 11, scanner 1028 includes two separate scanning mirror assemblies 1030, 1040, each including a scanning mirror 1032, 1042, where each scanning mirror scans the beam in one dimension. For example, scanning mirror 1032 scans the pulsed fanned beam in the fast scan direction, and scanning mirror 1042 scans the pulsed fanned beam in the slow scan direction.

Scanning mirror assemblies 1030, 1040 are driven by signals received from control logic 140 (FIGS. 1, 3). For example, scanning mirror 1032 may scan in one dimension according to a first commanded angle on the first dimension as a result of being driven by a first control signal, and scanning mirror 1042 may scan in a second dimension according to a second commanded angle on the second dimension as a result of being driven by a second control signal. In some embodiments, the instantaneous angular deflection of scanning mirror assemblies 1030 and 1040 are independently controlled, resulting in a completely configurable field of view along with configurable scan rates.

Although scanner 1028 is shown including two scanning mirror assemblies, where each scans in a separate dimension, this is not a limitation of the various embodiments described herein. For example, in some embodiments, scanner 1028 is implemented using a single biaxial scanning mirror assembly that scans in two dimensions. In some embodiments, scanning devices uses electromagnetic actuation, achieved using a miniature assembly containing a MEMS die and small subassemblies of permanent magnets and an electrical interface, although the various embodiments are not limited in this respect.

Exit optical devices 1050 operate on the scanning pulsed fanned laser beam as it leaves the transmit module. In some embodiments, exit optical devices 1050 perform field expansion. For example, scanning mirror assembly 1028 may scan through maximum angular extents of 20 degrees on the fast scan axis, and may scan through maximum angular extents of 40 degrees on the slow scan axis, and exit optical devices 1050 may expand the field of view to 30 degrees on the fast scan axis and 120 degrees on the slow scan axis. The relationship between scan angles of scanning mirrors and the amount of field expansion provided by exit optical devices 1050 is not a limitation of the various embodiments described herein.

In some embodiments, laser diodes 1112, 1114, 1116, and 1118 are high power multimode laser diodes. Multimode laser diodes typically have relatively large emitter areas that result in a beam that diverges faster on one axis than on the other axis. For example, an example 905 nm multimode laser diode may have a 10 um emitter on the fast axis and a 220 um emitter on the slow axis resulting in an emitted beam that inherently diverges faster on the slow axis. Various embodiments take advantage of this non-uniform beam shape by collimating the beam on the axis that naturally diverges more slowly, and focusing the beam into a fan on the axis that naturally diverges more quickly.

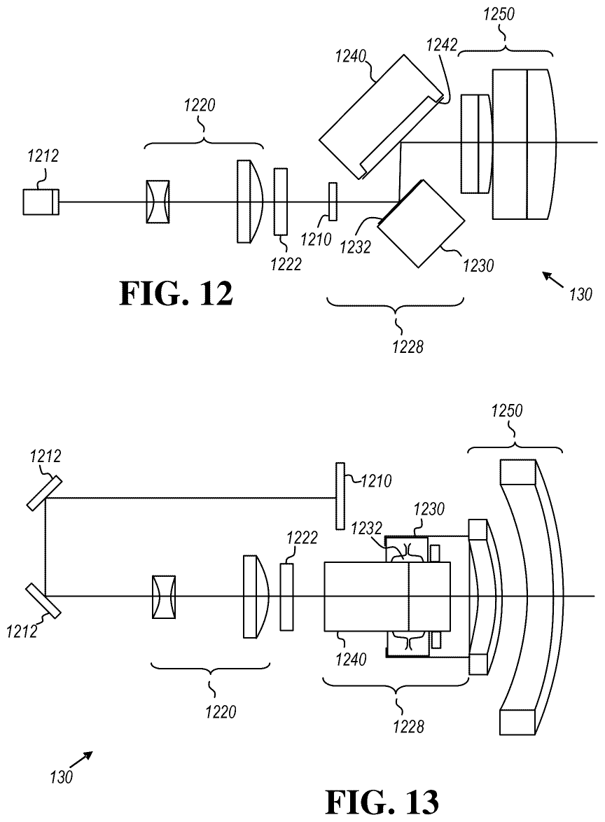

FIG. 12 shows a side view and FIG. 13 shows a top view of a receive module in accordance with various aspects described herein. Receive module 130 includes arrayed receiver 1210, fold mirrors 1212, imaging optical devices 1220, bandpass filter 1222, scanner 1228, and exit optical devices 1250.

Scanning mirror assemblies 1230 and 1240 are similar or identical to scanning mirror assemblies 1030 and 1040, and exit optical devices 1250 are similar or identical to exit optical devices 1050. Bandpass filter 1222 passes the wavelength of light that is produced by laser light source 1010 and blocks ambient light of other wavelengths. For example, in some embodiments, laser light source produces light at 905 nm, and bandpass filter 1222 passes light at 905 nm.

Imaging optical devices 1220 image a portion of the field of view onto arrayed receiver 1210 after reflection by fold mirrors 1212. For example, in some embodiments, optical devices 1220 image the area 126 (FIG. 1) onto arrayed receiver 1210. Because scanner 1228 is scanned synchronously with scanner 1028, arrayed receiver 1210 always collects light from the measurement points illuminated by the scanned pulsed fanned beam.

Arrayed receiver 1210 includes an array of light sensitive devices. The array of light sensitive devices may be one-dimensional or two-dimensional. For example, in some embodiments, arrayed receiver 1210 includes a 1×M array of PIN photodiodes, Silicon photomultipliers (SiPM), avalanche photodiodes (APD), or the like, where M is any integer. Also for example, in some embodiments, arrayed receiver 1210 includes a N×M array of PIN photodiodes, Silicon photomultipliers (SiPM), avalanche photodiodes (APD), or the like, where N and M are any integers. Any number of light sensitive devices may be included without departing from the scope of the various embodiments described herein. For example, in some embodiments, 16 light sensitive devices are included, and in other embodiments, 24 light sensitive devices are included.

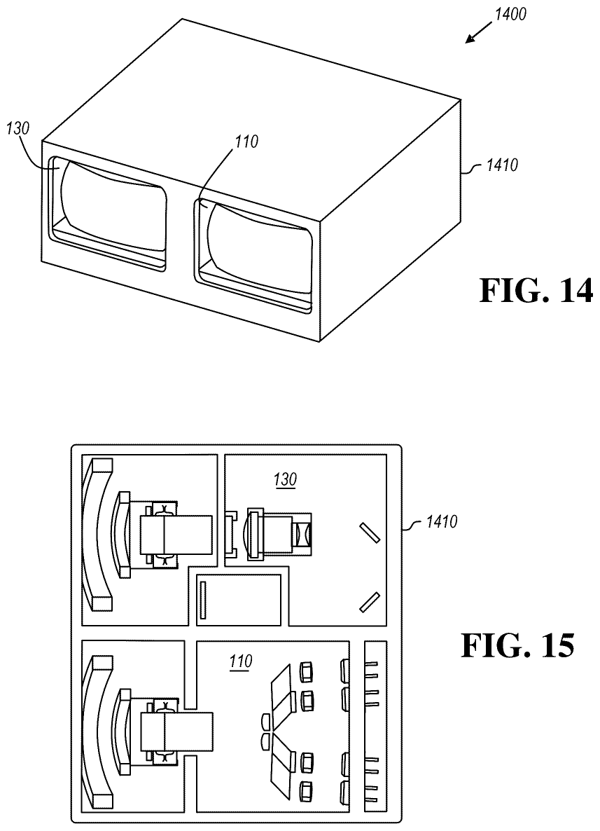

FIG. 14 shows a perspective view of an integrated photonics module in accordance with various embodiments described herein. Integrated photonics module 1400 is shown having a rectangular housing 1410 with transmit module 110 and receive module 130 placed side by side. In some embodiments, transmit module 110 and receive module 130 are placed one on top of the other. The relative orientation of transmit module 110 and receive module 130 is not a limitation of the various embodiments described herein.

FIG. 15 shows a cross sectional top view of the integrated photonics module of FIG. 14. Transmit module 110 and receive module 130 are shown side by side. In some embodiments, space is provided for electronics above and below the rearmost optical devices in integrated photonics module 1400. Any amount of system electronics may be included within module 1400. For example, in some embodiments, all components shown in FIG. 1 are included in module 1400. Also for example, in some embodiments, only control logics and TOF measurement circuits are included in module 1400.

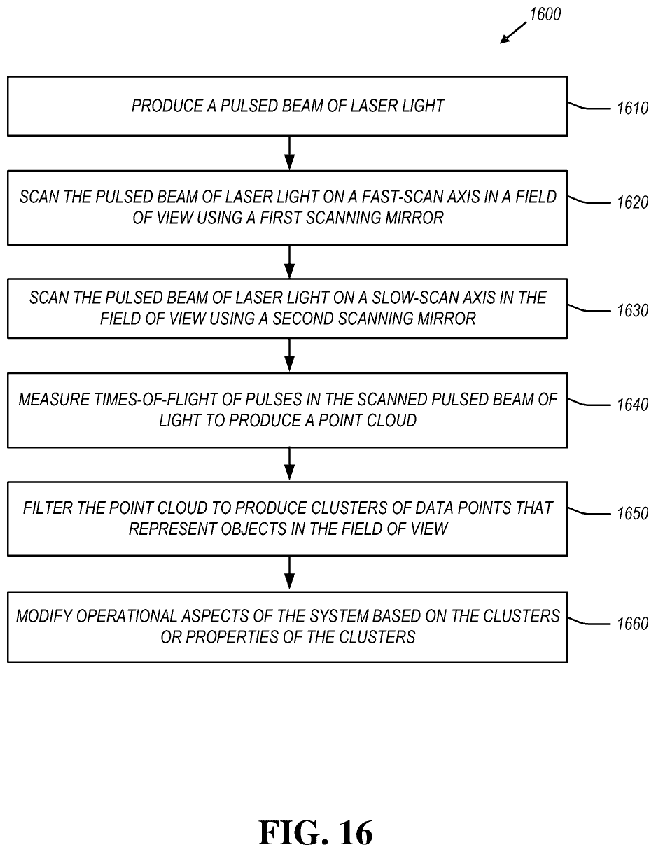

FIG. 16 shows a flow diagram of methods in accordance with various aspects described herein. In some embodiments, method 1600, or portions thereof, is performed by a MEMS system, a scanning LIDAR system, a scanning LIDAR module, or a point cloud processing system. In other embodiments, method 1600 is performed by a series of circuits or an electronic system. Method 1600 is not limited by the particular type of apparatus performing the method. The various actions in method 1600 may be performed in the order presented or may be performed in a different order. Further, in some embodiments, some actions listed in FIG. 16 are omitted from method 1600.

Method 1600 is shown beginning with block 1610 in which a pulsed beam of laser light is produced. In some embodiments, the actions of block 1610 may be performed by a laser module that generates laser light pulses in response to a drive signal. For example, the laser module 630 generates laser light pulses in response to a drive signal received from laser driver 340. Laser driver 340 produces the drive signal in response to control signal(s) received from digital logic 330.

At 1620, the pulsed beam of laser light is scanned on a fast-scan axis in a field of view using a first scanning mirror. In some embodiments, the actions of block 1620 may be performed by a fast-scan MEMS mirror that varies in angular velocity to scan the pulsed beam of laser light on a fast scan axis. For example, the fast-scan MEMS mirror 620 reflects the laser light pulses and scans the received laser light pulses on a fast scan trajectory component. In some embodiments, fast-scan MEMS mirror 620 reflects laser light pulses received from laser module 630, and slow-scan MEMS mirror 610 reflects laser light pulses received from fast-scan MEMS mirror 620. The fast-scan MEMS mirror 620 is driven by the fast-scan MEMS dynamical control 654, which receives digital signals from the digital logic 330 and converts them into analog signals to drive the MEMS mirrors.

At 1630 the pulsed beam of laser light is scanned on a slow-scan axis in the field of view using a second scanning mirror. In some embodiments, the actions of block 1630 may be performed by a slow-scan MEMS mirror that moves to scan the laser light on a slow scan axis. For example, the slow-scan MEMS mirror 610 reflects laser light pulses received from laser module 630 and scans the received laser light pulses on a slow scan trajectory component. In some embodiments, slow-scan MEMS mirror 610 reflects laser light pulses received from fast-scan MEMS mirror 620. The slow-scan MEMS mirror 610 is driven by the slow-scan MEMS dynamical control 652, which receives digital signals from the digital logic 330 and converts them into analog signals to drive the MEMS mirrors.

At block 1640, the method involves measuring times-of-flight of pulses in the scanned pulsed beam of light to produce a point cloud. In some embodiments, this action is performed by time-of-flight measurement circuits, such as TOF measurement circuits 150, which calculate the distance to objects in the field of view based on the round-trip time of the laser pulses. The resulting data points are stored in a point cloud storage device, such as point cloud storage 160.

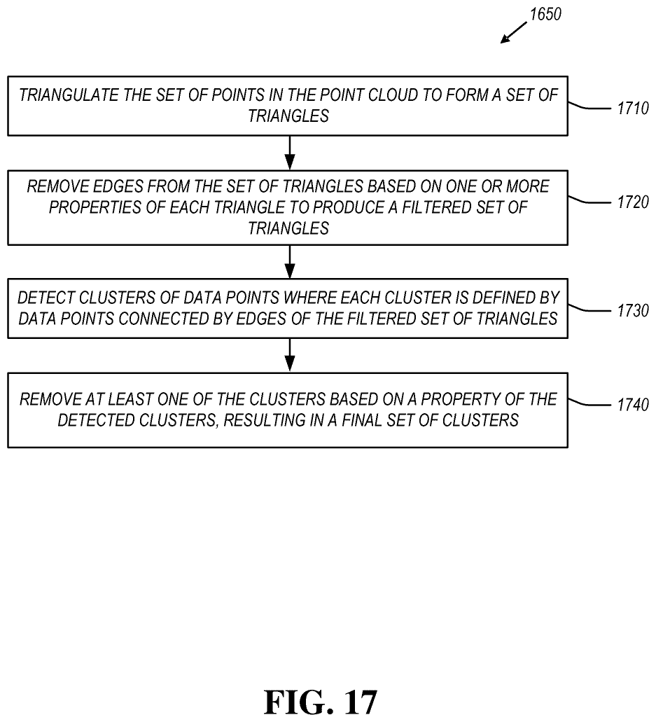

At block 1650, the method involves filtering the point cloud to produce clusters of data points that represent objects in the field of view. In some embodiments, this action is performed by point cloud processing, such as point cloud processing 170, which applies a triangulation-based filtering algorithm. For example, the system may use Delaunay triangulation to form triangles, remove edges based on intrinsic and extrinsic properties, and identify clusters of data points that likely correspond to real objects. The actions of block 1650 are described further below with reference to FIG. 17.

At block 1660, the method involves modifying operational aspects of the system based on the clusters or properties of the clusters. In some embodiments, this action includes adjusting the field of view, resolution, or laser power of the LIDAR system to focus on regions of interest identified by the clusters. For example, the system may increase the resolution in areas where clusters indicate the presence of real objects or modify the scanning trajectory to enhance data acquisition in critical regions.

In some embodiments, the field of view of the LIDAR system may be dynamically adjusted based on the spatial distribution of the detected clusters. For example, the system may narrow the field of view to concentrate on regions of interest where clusters suggest the presence of objects, such as vehicles, pedestrians, or obstacles. Conversely, the field of view may be expanded in areas where fewer clusters are detected to perform broader environmental scanning.

In some embodiments, the resolution of the LIDAR system may also be modified during data acquisition. For example, the system may increase the angular resolution in areas where clusters are densely packed, indicating the presence of complex or closely spaced objects. This adjustment captures finer details of objects in the field of view, which may be useful for applications such as autonomous navigation or object recognition. In contrast, the resolution may be reduced in areas with sparse or no clusters to conserve processing power and system resources.

In some embodiments, the laser power of the LIDAR system may be adjusted based on the properties of the clusters. For example, the system may increase the laser power in regions identified as areas of interest to improve the signal-to-noise ratio and provide for accurate detection of objects at greater distances. This adjustment may be particularly useful in scenarios where clusters are located far from the LIDAR sensor or in environments with high ambient light interference, such as direct sunlight.

In some embodiments, the scanning trajectory components of the LIDAR system may be modified to focus on regions of interest. For example, the angular velocity of the scanning mirrors may be reduced when scanning areas with high cluster density to allow for more detailed data acquisition. Conversely, the angular velocity may be increased in areas with low cluster density to expedite scanning and improve overall system efficiency. This adaptive scanning approach allows the LIDAR system to allocate resources effectively based on the detected clusters.

Additional operational aspects of the LIDAR system that may be modified include the pulse repetition rate of the laser light source. For example, the system may increase the pulse repetition rate in regions of interest to gather higher-density point cloud data, enabling more precise object detection and classification. Similarly, the pulse width of the laser light source may be adjusted to deposit additional energy into the scene, increasing the likelihood of sufficient photon returns for accurate measurements.

The system may also modify the normalization of edge lengths in the triangulation process based on the distance of the clusters from the LIDAR sensor. For example, edge lengths may be normalized to allow for longer edges in clusters located farther away, allowing meaningful relationship to be maintained across varying distances. This adjustment enhances the accuracy of the filtering process and prevents distant clusters from being erroneously discarded.

In some embodiments, the system may dynamically adjust its operational parameters to account for environmental conditions or application-specific requirements. For instance, in an automotive application, the LIDAR system may focus on clusters representing nearby vehicles or pedestrians during urban driving, while expanding its field of view and reducing resolution during highway driving to monitor a broader area.

While for purposes of simplicity of explanation, the respective processes are shown and described as a series of blocks in FIG. 16, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 17 depicts an illustrative embodiment of a method 1650 in accordance with various aspects described herein. In some embodiments, method 1650, or portions thereof, is performed by a MEMS system, a scanning LIDAR system, a scanning LIDAR module, or a point cloud processing system. In other embodiments, method 1650 is performed by a series of circuits or an electronic system. Method 1650 is not limited by the particular type of apparatus performing the method. The various actions in method 1650 may be performed in the order presented or may be performed in a different order. Further, in some embodiments, some actions listed in FIG. 17 are omitted from method 1650.

At block 1710, the method involves triangulating the set of points in the point cloud to form a set of triangles. In some embodiments, this action is performed by point cloud processing, such as point cloud processing 170, which applies triangulation (e.g., Delaunay triangulation) to create a structured network of triangles. Delaunay triangulation is particularly effective for providing for uniformity in the shape of triangles and avoiding sliver triangles that could compromise subsequent analysis. Alternatively, polygon triangulation or other triangulation methods may be employed to form the set of triangles. The triangulation process operates in linear time, i.e., O(N), providing computational efficiency even for large point clouds. This process provides a framework for analyzing spatial relationships between data points.

The point cloud includes a set of data points that may exist in N-dimensional space, where N can be greater than three. In some embodiments, the data points are represented in three-dimensional space with coordinates (X, Y, Z), where X and Y represent spatial dimensions, and Z represents depth or distance from the LIDAR sensor. However, in some embodiments, the point cloud may include additional dimensions that provide further context or information about the environment.

For example, in four-dimensional space, the data points may include a timestamp T associated with each measurement, representing the time at which the point was captured. This additional dimension allows the system to analyze temporal changes in the environment, such as the movement of objects over time.

In five-dimensional space, the data points may include intensity I, which represents the strength of the reflected laser signal. Intensity data can be used to distinguish between different types of surfaces or materials, such as differentiating between reflective surfaces like metal and less reflective surfaces like wood or fabric.

In six-dimensional space, the data points may include color information (R, G, B), where R, G, and B represent the red, green, and blue color channels of the reflected light. This information can be useful for applications requiring detailed object recognition or classification, such as identifying traffic signs or distinguishing between vehicles and pedestrians.

In higher-dimensional space, the data points may include additional properties such as velocity V, representing the speed of an object relative to the LIDAR sensor, or classification labels C, indicating the type of object detected (e.g., vehicle, pedestrian, tree). These additional dimensions enable the system to perform more sophisticated analyses and provide richer insights into the environment.

By accommodating N-dimensional data, the triangulation process provides a robust framework for analyzing complex environments and extracting meaningful information from the point cloud. The resulting system can adapt to diverse applications and requirements, ranging from basic spatial mapping to advanced object recognition and tracking.

At block 1720, the method involves removing edges from the set of triangles based on one or more properties of each triangle to produce a filtered set of triangles. The actions of block 1720 refine the triangulated representation of the point cloud and isolate meaningful relationships between data points. Intrinsic properties of the triangles, such as edge length, angles between vertices, and the area of triangles, are analyzed to determine which edges should be retained. Edges that are excessively long may indicate connections between points that are not spatially related, such as edges connecting points on opposite sides of a large gap or noise artifacts, and may be removed. Shorter edges are prioritized for retention, as they are more likely to represent meaningful relationships between nearby points. Triangles with highly skewed angles, such as those forming sliver shapes, may be discarded, as triangles with angles below a certain threshold are less structurally robust. Similarly, triangles with unusually large areas may represent connections between points that are not part of the same object or surface, such as triangles spanning large voids or connecting points across different clusters, and may be removed.

Extrinsic properties, which in some embodiments depend on the spatial relationship between the points and the LIDAR sensor, may also be considered. For example, edge lengths may be normalized based on the distance of the points from the LIDAR sensor, allowing longer edges for points farther from the sensor due to the lower spatial resolution at greater distances. This normalization may preserve meaningful relationships across varying distances. In some embodiments, edge lengths may be weighted individually for each spatial component, such as X, Y, and Z, to account for variations in the spatial domain. For example, edges may be weighted more heavily in the vertical dimension if the LIDAR system is scanning a tall structure, such as a building or tree. The normalization process adjusts edge lengths to account for spatial variations and allows meaningful relationships to be maintained across varying distances.

The edge removal process is particularly effective for filtering out noise artifacts and outliers. Edges connecting points that are likely noise, such as random reflections caused by sunlight or other environmental factors, may be removed. For example, edges connecting isolated points with no nearby neighbors may be discarded. Similarly, edges connecting points that are spatially distant from the main cluster of triangles may be removed, such as edges connecting points on opposite sides of a road or between unrelated objects. Edges forming triangles that extend beyond the boundaries of an object may also be removed to improve the accuracy of the representation, such as edges connecting points on the surface of a vehicle to points on the ground.

In some embodiments, the edge removal process may be performed iteratively to refine the filtered set of triangles. The system may first remove edges based on intrinsic properties, such as edge length and angles, and then apply extrinsic property filters, such as distance normalization. The process may be repeated to remove all irrelevant edges and to allow only meaningful connections to remain. The filtered set of triangles that remain represents a refined network of connections between data points that are more likely to correspond to real objects or surfaces in the environment.

At block 1730, the method involves detecting clusters of data points, where each cluster is defined by data points connected by edges of the filtered set of triangles. In some embodiments, a cluster may be defined as a set of points connected through one or more edges, meaning any two points in the cluster may be reached by traversing the edges. The system may group vertices based on their connectivity through the retained edges, isolating regions of the point cloud that are more likely to represent real objects. For example, the vertices connected by the retained edges may represent points on the surface of a detected object. The clustering process may leverage the connectivity of the remaining edges to form cohesive groups of data points. In some embodiments, clusters are explicitly formed by traversing edges belonging to the remaining triangles, ensuring that all points within a cluster are reachable through a series of connected edges.

The number of clusters formed during this process may vary depending on the spatial distribution of the data points in the point cloud and the properties of the filtered triangles. In some embodiments, the system may identify a single large cluster encompassing many connected points, while in other embodiments, multiple smaller clusters may be formed, each representing distinct regions of connectivity. The clustering process is not limited to three-dimensional space; it may operate in N-dimensional space, where N may be greater than three. For example, in four-dimensional space, clusters may be formed based on spatial proximity and temporal relationships, such as points that are close in both space and time. In five-dimensional space, clusters may incorporate intensity values, grouping points with similar reflectivity. In six-dimensional space, clusters may include color information, grouping points based on shared color characteristics. In other embodiments, higher-dimensional clustering may also consider additional properties, such as velocity or classification labels, to form clusters that reflect complex relationships between data points.

While some clusters formed during this process may correspond to real objects in the field of view, others may not. Clusters that correspond to real objects typically exhibit cohesive spatial relationships and satisfy certain intrinsic and extrinsic properties, such as having a sufficient number of points, occupying a plausible volume, and being located within a reasonable distance from the LIDAR sensor. For example, a cluster may represent the surface of a vehicle, a pedestrian, or a tree, with points that are spatially connected and form a recognizable shape. Alternatively, clusters that do not correspond to real objects may arise from noise, artifacts, or random reflections caused by environmental factors such as sunlight or ambient light interference. These clusters may exhibit irregular spatial distributions, contain too few points, or occupy implausibly large or small volumes, making them unlikely to represent meaningful objects.

The clustering process may isolate regions of the point cloud that are more likely to represent real objects while distinguishing them from noise or unrelated data points. By analyzing the connectivity of the retained edges and the properties of the resulting clusters, the filtered point cloud may more accurately reflect the sensed environment. This step may provide a reliable foundation for further refinement, such as filtering out clusters that do not meet specific thresholds or dynamically adjusting the LIDAR system's operational parameters based on the properties of the detected clusters.

At block 1740, the method involves removing at least one of the clusters based on a property of the detected clusters, resulting in a final set of clusters. This step refines the point cloud by filtering out clusters that are unlikely to represent real objects in the field of view. In some embodiments, intrinsic properties of the clusters, such as the number of points in the cluster, the volume occupied by the cluster, and the spatial distribution of the points, may be analyzed to determine whether a cluster should be retained or removed. For example, clusters with too few points may be discarded as noise, as they are unlikely to represent meaningful objects. Similarly, clusters with an implausibly large volume or irregular spatial distributions may be removed, as these characteristics often indicate artifacts or noise rather than real objects. In some embodiments, block 1740 is skipped. In these embodiments, the final set of clusters includes all of the clusters detected by the actions of block 1730.

Extrinsic properties, such as the distance of the cluster from the LIDAR sensor, may also be considered during the filtering process. For example, clusters located at extreme distances from the sensor may be removed if their spatial characteristics suggest they are artifacts rather than meaningful reflections. In some embodiments, clusters are further filtered based on the total volume of tetrahedra associated with the points in the cluster. The resulting clusters with plausible volumes are retained, as clusters with excessively large or small tetrahedral volumes are unlikely to correspond to real objects.

FIG. 9 illustrates the results of this filtering process, showing retained clusters 910 and removed clusters 920. The retained clusters 910, shown in black, represent groups of data points that are likely to correspond to real objects in the sensed environment. For example, these clusters may correspond to surfaces of objects such as vehicles, pedestrians, or trees. The retained clusters exhibit cohesive spatial relationships, plausible volumes, and sufficient numbers of points, making them reliable representations of real objects. Conversely, the removed clusters 920, shown in gray, represent groups of data points that do not meet specific thresholds for intrinsic or extrinsic properties. These clusters may include noise caused by environmental factors such as sunlight or ambient light interference, as well as artifacts resulting from random reflections. For example, clusters with irregular spatial distributions, too few points, or implausibly large volumes are discarded as noise.

The filtering process produces a final set of clusters that more accurately reflect the sensed environment by isolating meaningful data points and removing irrelevant or noisy data. The retained clusters 910 provide a reliable foundation for further analysis or application, such as object detection, environmental mapping, or adaptive scanning. For example, the final set of clusters may be used to dynamically adjust the resolution or field of view of the LIDAR system, focus on regions of interest, or modify the power output of the laser light source. By removing clusters that do not correspond to real objects, the system enhances the accuracy and reliability of the point cloud data, and produces a data set that it is well-suited for practical applications.

In some embodiments, the filtering process may be adaptive, allowing the system to adjust its thresholds for intrinsic and extrinsic properties based on environmental conditions or application-specific requirements. For example, in an automotive application, the system may prioritize clusters representing nearby vehicles or pedestrians during urban driving, while expanding its field of view and reducing resolution during highway driving to monitor a broader area. This adaptive capability provides efficient operation of the LIDAR system while maintaining high-resolution data in areas of interest within the field of view.

The filtered set of clusters provides a reliable representation of the sensed environment and serves as the foundation for further analysis or application. For example, the final set of clusters may be used to dynamically adjust the resolution or field of view of the LIDAR system, focus on regions of interest, or modify the power output of the laser light source. In some embodiments, the system may increase the pulse repetition rate in regions of interest to gather higher-density point cloud data, enabling more precise object detection and classification. Similarly, the pulse width of the laser light source may be adjusted to deposit additional energy into the scene, increasing the likelihood of sufficient photon returns for accurate measurements. The system may also modify the normalization of edge lengths in the triangulation process based on the distance of the clusters from the LIDAR sensor, allowing meaningful relationships to be maintained across varying distances.

In some embodiments, the system dynamically adjusts its operational parameters to account for environmental conditions or application-specific requirements. For instance, in an automotive application, the LIDAR system may focus on clusters representing nearby vehicles or pedestrians during urban driving, while expanding its field of view and reducing resolution during highway driving to monitor a broader area.

While for purposes of simplicity of explanation, the respective processes are shown and described as a series of blocks in FIG. 17, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A light detection and ranging (LIDAR) system comprising:
a laser light source;
at least one light sensitive device;
at least one time-of-flight measurement circuit responsive to the at least one light sensitive device;
a point cloud storage device to store a set of data points as measured by the at least one time-of-flight measurement circuit;
a processing system including a processor, the processing system being coupled to the point cloud storage device; and
a memory that stores executable instructions that, when executed by the processing system, facilitate performance of operations, the operations comprising:
triangulating the set of data points in the point cloud storage device to form a set of triangles, wherein each triangle in the set of triangles includes edges and vertices;
removing edges from the set of triangles based on one or more properties of each triangle in the set of triangles to produce a filtered set of triangles;
detecting clusters of data points to produce detected clusters, wherein each cluster of the detected clusters comprises data points connected by edges of the filtered set of triangles; and
removing at least one of the detected clusters based on a property of the detected clusters, resulting in a final set of clusters.

2. The LIDAR system of claim 1, wherein the one or more properties of each triangle in the set of triangles include a distance of the triangle from the LIDAR system.

3. The LIDAR system of claim 1, wherein the property of the detected clusters include a number of data points in each of the detected clusters.

4. The LIDAR system of claim 1, wherein the property of the detected clusters include a volume occupied by each of the detected clusters.

5. The LIDAR system of claim 1, the operations further comprising adjusting a field of view of the LIDAR system based on a spatial distribution of the detected clusters.

6. The LIDAR system of claim 1, the operations further comprising adjusting a resolution of the LIDAR system based on a spatial distribution of the detected clusters.

7. The LIDAR system of claim 1, wherein the triangulating comprises performing Delaunay triangulation on the set of data points in the point cloud storage device to form the set of triangles.

8. The LIDAR system of claim 1, wherein the triangulating comprises performing polygon triangulation on the set of data points in the point cloud storage device to form the set of triangles.

9. The LIDAR system of claim 1, wherein the operations further comprise normalizing lengths of the edges in the point cloud storage device based on distance from the LIDAR system, such that edges farthest from the LIDAR system are reduced.

10. A system comprising:
a light detection and ranging (LIDAR) sensor configured to generate a point cloud that includes a set of data points;
a processing system including a processor, the processing system being coupled to the LIDAR sensor; and
a memory that stores executable instructions that, when executed by the processing system, facilitate performance of operations, the operations comprising:
triangulating the set of data points in the point cloud to form a set of triangles, wherein each triangle in the set of triangles includes edges and vertices;
removing edges from the set of triangles based on one or more properties of each triangle in the set of triangles to produce a filtered set of triangles;
detecting clusters of data points, wherein each cluster of the clusters comprises data points connected by edges of the filtered set of triangles; and
removing at least one of the clusters based on a property of the clusters, resulting in a final set of clusters representing likely real objects in the point cloud.

11. The system of claim 10, wherein the one or more properties of each triangle in the set of triangles include an edge length.

12. The system of claim 10, wherein the one or more properties of each triangle in the set of triangles include an angle between edges.

13. The system of claim 10, wherein the one or more properties of each triangle in the set of triangles include an area of the triangle.

14. The system of claim 10, wherein the operations further comprise normalizing lengths of the edges in the point cloud based on distance from the LIDAR sensor, such that edges farthest from the LIDAR sensor are reduced.

15. A method comprising:
triangulating, by a processing system including a processor, a set of data points in a point cloud to form a set of triangles, wherein each triangle in the set of triangles includes edges and vertices;
removing, by the processing system, one or more edges from the set of triangles based on one or more properties of each triangle in the set of triangles to produce a filtered set of triangles;
detecting, by the processing system, one or more clusters of data points to produce detected clusters, wherein each cluster of the detected clusters comprises data points connected by edges of the filtered set of triangles; and
removing, by the processing system, at least one of the detected clusters based on one or more cluster properties, resulting in a final set of clusters representing likely real objects in the point cloud.

16. The method of claim 15, further comprising modifying, by the processing system, a power of a laser light source in a light detection and ranging (LIDAR) system based on at least one property of the final set of clusters.

17. The method of claim 15, further comprising adjusting scanning trajectory components of a light detection and ranging (LIDAR) system based on at least one property of the final set of clusters.

18. The method of claim 15, further comprising adjusting a resolution of a light detection and ranging (LIDAR) system based on at least one property of the final set of clusters.

19. The method of claim 15, wherein the triangulating comprises performing Delaunay triangulation on the set of data points in the point cloud to form the set of triangles.

20. The method of claim 15, further comprising normalizing edge lengths of each triangle in the set of triangles based on distances from a LIDAR sensor to produce normalized edge lengths, wherein the removing the one or more edges from the set of triangles based on the one or more properties of each triangle in the set of triangles to produce the filtered set of triangles comprises removing the one or more edges based on the normalized edge lengths.
